(19) United States
(12) Patent Application Publication
(10) Pub. No.: US 2006/0219079 A1
(43) Pub. Date: Oct. 5, 2006

(54) Apparatus for cutting concrete

(76) Inventor: Charlie Zhang, Oak Brook, IL (US)

Correspondence Address: Kevin D. Erickson;Pauley Petersen & Erickson, Suite 365, 2800 West Higgins Road, Hoffman Estates, IL, 60195, US

(21) Appl. No.: 11/098,739

(22) Filed: Apr. 4, 2005

(51) Int. Cl. B26D 1/00

(52) U.S. Cl. 83/651

(57) ABSTRACT

A flexible track conveyor apparatus for cutting a surface of concrete, particularly, green concrete. The apparatus includes a frame with first and second track conveyors disposed at opposed lateral sides thereof and with a blade mount for mounting a rotatable cutting blade disposed between the first and second track conveyors. The apparatus may also include conventional features such as a motor and a handle.

### BACKGROUND OF THE INVENTION

This invention relates generally to concrete and, more particularly, to an apparatus for cutting concrete. More specifically, the invention relates to a track conveyor concrete cutting apparatus particularly suited for cutting “green” or not fully cured concrete.

The surfaces of large slabs of concrete are known to be prone to cracking such as may occur as a result of expansion and contraction as the slab of concrete cures. Such expansion and contraction of a concrete slab are typically dependent on numerous factors. In view thereof, various techniques or approaches for avoiding, reducing or otherwise effectively controlling such cracking have been proposed or developed. One commonly employed approach for avoiding, reducing or otherwise effectively controlling such cracking is through the introduction of control joints or seams in the concrete surface as the concrete is curing.

While such control joints or seams can be created or established by various techniques, the cutting of a concrete surface by means of a saw or blade is an established technique for forming or introducing such control joints or seams into a concrete surface. In particular, the formation of cuts or grooves in relatively fresh, e.g., green, concrete slabs is a common technique that has been employed to avoid, reduce or otherwise effectively control such cracking. As used herein, “green concrete” generally refers to not yet fully cured concrete and, more specifically to concrete within one to several hours after pouring such as dependent, at least in part, on the concrete mixture that is being employed.

When cutting or forming such control joints or seams in a concrete surface, it is generally desirable to avoid or minimize otherwise marking or marring the surface of the concrete in the vicinity of the joint or seam. That is, it is generally desirable that the joint or seam be cleanly cut or otherwise formed in the concrete surface such that surface chipping, spalling or ravelling is minimized or avoided. Moreover, at least for appearance sake, it is generally desired that such cut control joints or seams be formed in relatively straight line fashion.

Those skilled in the art will appreciate that newly laid concrete, in particular green concrete such that has just begun to cure cannot readily support heavy machinery or equipment, such as may otherwise be desirably employed to effect the cutting of the surface of the concrete. In particular, the weight of such heavy machinery or equipment bearing on the not yet cured concrete surface may result in undesirable surface marking or degradation.

Consequently, various hand-operated concrete cutting assemblies, including various manually-operated, walk-behind concrete cutting assemblies, have been developed. However, even such hand-operated assemblies may result in undesirable concentrations of force against an associate green concrete surface. For example, such hand-operated concrete cutting assemblies commonly incorporate or employ conveyance systems, such as to effect movement of the assembly over the green concrete surface. Conveyance systems utilized with hand-operated concrete cutting assemblies typically rely on wheels or relatively narrow rollers to convey the assembly across the green concrete surface. Unfortunately, the wheels or rollers of such assemblies can act or serve to undesirably concentrate or focus the weight of the assembly onto an underlying surface such as to result in the marking or marring of such an underlying concrete surface.

Thus, there is a need and a demand for an apparatus for cutting a surface of concrete over which the apparatus is conveyed and which apparatus desirably minimizes or avoids surface marking or marring in the vicinity of the joint or seam cut into the concrete, i.e., green concrete, surface. Further, there is a need and a demand for such an apparatus that avoids undesirably concentrating or focusing the weight of the assembly such as to avoid undesired marking or marring of the concrete surface.

### SUMMARY OF THE INVENTION

A general object of the invention is to provide an improved apparatus for cutting concrete.

A more specific objective of the invention is to overcome one or more of the problems described above.

The general object of the invention can be attained, at least in part, through a specified apparatus for cutting a surface of concrete over which the apparatus is conveyed. In accordance with one preferred embodiment of the invention, such an apparatus includes a frame having opposed and spaced apart lead and trail ends. The frame also has opposed and spaced apart first and second lateral sides. A first flexible track conveyor assembly is generally disposed along the frame first lateral side. The first flexible track conveyor assembly includes a first endless flexible track conveyor disposed about first track supports along the frame first lateral side, wherein the first track supports consist essentially of supports fixed relative to the frame. A second flexible track conveyor assembly is generally disposed along the frame second lateral side. The second flexible track conveyor assembly includes a second endless flexible track conveyor disposed about second track supports along the frame second lateral side, wherein the second track supports consist essentially of supports fixed relative to the frame. A blade mount is disposed between the first and second endless flexible track conveyors. The blade mount is for mounting a rotatable cutting blade effective to cut concrete and permits vertical adjustment of the rotatable cutting blade relative to the frame. A motor is in operational communication with the rotatable cutting blade effective to rotate the cutting blade to cut into the surface of concrete over which the apparatus is conveyed. A motor is in operational communication with the first and second track conveyor assemblies effective to rotate the first and second flexible track conveyors, respectively. A handle is fixedly connected to the frame and is effective for guiding the apparatus across a surface of concrete to be cut.

The prior art generally fails to provide an apparatus for cutting concrete, particularly green concrete, and which apparatus minimizes or avoids, to the extent desired, surface marking or marring in the vicinity of the joint or seam cut into the concrete surface. The prior art also generally fails to provide an apparatus for cutting concrete, particularly green concrete, and which apparatus avoids undesirably concentrating or focusing the weight of the assembly such as to minimize or avoid undesired marking or marring of the concrete surface.

The invention further comprehends an apparatus for cutting concrete that, in accordance with another embodiment, includes a frame having opposed and spaced apart lead and trail ends. The frame also has opposed and spaced apart first and second lateral sides. A first flexible track conveyor assembly is generally disposed along the frame first lateral side and a second flexible track conveyor assembly is generally disposed along the frame second lateral side. The first flexible track conveyor assembly includes a first endless flexible track conveyor having a plurality of aligned individual first conveyor plates. The first flexible track conveyor assembly also includes a first drive assembly at least in part fixed relative to the frame. The first drive assembly has at least a first sprocket wheel in operational communication with a portion of the plurality of aligned individual first conveyor plates and is effective to drive the first endless flexible track conveyor. The second flexible track conveyor assembly includes a second endless flexible track conveyor having a plurality of aligned individual second conveyor plates. The second flexible track conveyor assembly also includes a second drive assembly at least in part fixed relative to the frame. The second drive assembly has at least a second sprocket wheel in operational communication with a portion of the plurality of aligned individual second conveyor plates and is effective to drive the second endless flexible track conveyor. A blade mount is disposed between the first and second endless flexible track conveyors. The blade mount is for mounting a rotatable cutting blade effective to cut concrete and permits vertical adjustment of the rotatable cutting blade relative to the frame. A motor is in operational communication with the rotatable cutting blade effective to rotate the cutting blade to cut into the surface of concrete over which the apparatus is conveyed. The motor is also in operational communication with the first and second track conveyor assemblies effective to rotate the first and second flexible track conveyors, respectively. A handle is fixedly connected to the frame and is effective for guiding the apparatus across a surface of concrete to be cut.

The invention still further comprehends an apparatus for cutting a surface of concrete, wherein flexible track conveyors form the primary means of support for the apparatus on a surface of concrete over which the apparatus is conveyed. In accordance with one preferred embodiment of the invention, such an apparatus includes a frame having opposed and spaced apart lead and trail ends and also having opposed and spaced apart first and second lateral sides. A first flexible track conveyor assembly is generally disposed along the frame first lateral side and a second flexible track conveyor assembly is generally disposed along the frame second lateral side. The first flexible track conveyor assembly includes a first endless flexible track conveyor and the second flexible track conveyor assembly includes a second endless flexible track conveyor. A blade mount is disposed between the first and second endless flexible track conveyors. The blade mount is for mounting a rotatable cutting blade effective to cut concrete and permits vertical adjustment of the rotatable cutting blade relative to the frame. A motor is in operational communication with the rotatable cutting blade effective to rotate the cutting blade. The motor is also in operational communication with the first and second track conveyor assemblies effective to rotate the first and second flexible track conveyors, respectively. A handle is fixedly connected to the frame and is effective for guiding the apparatus across a surface of concrete to be cut.

Other objects and advantages will be apparent to those skilled in the art from the following detailed description taken in conjunction with the appended claims and drawings.

### BRIEF DESCRIPTION OF THE DRAWINGS

FIG. 1 is a fragmentary perspective view of an apparatus for cutting concrete in accordance with one preferred embodiment of the invention.

FIG. 2 is a simplified bottom view schematic of the apparatus for cutting concrete shown in FIG. 1.

FIG. 3 is a simplified bottom view schematic of an apparatus for cutting concrete in accordance with another preferred embodiment of the invention.

FIG. 4 is a simplified bottom perspective view showing selected portions of the apparatus for cutting concrete shown in FIG. 1.

FIG. 5 is a top plan view, corresponding to FIG. 4, and showing selected portions of the apparatus for cutting concrete shown in FIG. 1.

FIG. 6 is a side view, corresponding to FIGS. 4 and 5, showing selected portions of the apparatus for cutting concrete shown in FIG. 1.

FIG. 7 is detailed perspective view showing an adjacent pair of conveyor plates of an endless flexible track conveyor in accordance with one preferred embodiment of the invention.

### DETAILED DESCRIPTION OF THE INVENTION

The present invention provides an apparatus particularly suited for cutting “green” or not fully cured concrete. As described in greater detail below, the concrete cutting apparatus of the invention, at least in accordance with certain preferred embodiments, relies on flexible track conveyors as at least the primary or main means of support for the apparatus on a surface of concrete over which the apparatus is conveyed.

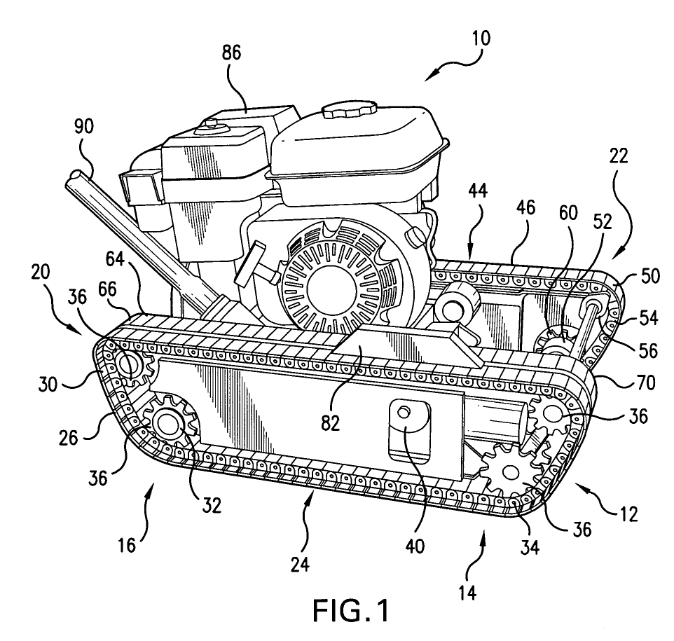

Turning to FIG. 1, there is illustrated a concrete cutting apparatus, generally designated by the reference numeral 10, in accordance with one preferred embodiment of the invention. The concrete cutting apparatus 10 generally includes a body frame 12. The body frame 12 has a lead or forward end 14 and a trail or rear end 16 that are generally opposed and spaced apart from each other. The body frame 12 also has opposed and spaced apart first and second lateral sides, 20 and 22, respectively.

A first flexible track conveyor assembly 24 is generally disposed along the frame first lateral side 20. The first flexible track conveyor assembly 24 includes a first endless flexible track conveyor 26 generally composed of a plurality of aligned individual first conveyor plates 30. The first flexible track conveyor assembly 24 also includes or has a first drive assembly 32, such as includes first track supports 34 along the frame first lateral side 20 whereabout the first endless flexible track conveyor 26 is generally disposed. The first drive assembly 32 is desirably at least in part fixed relative to the frame 12. In accordance with certain preferred embodiments of the invention, the first track supports 34 are desirably fixed relative to the frame 12. For example and as shown, the first drive assembly 32 includes a plurality of sprocket wheels 36, including a first sprocket wheel 40, such as are desirably rotatably fixed to the frame 12 and in operational communication with the first endless flexible track conveyor 26 and, more particularly, in operational communication with at least a portion of the plurality of aligned individual first conveyor plates 30. Thus, for example, the first drive assembly 32 is generally effective to drive the first endless flexible track conveyor 26.

A second flexible track conveyor assembly 44 is generally disposed along the frame second lateral side 22. The second flexible track conveyor assembly 44, similar to the first flexible track conveyor assembly 24, includes a second endless flexible track conveyor 46 generally composed of a plurality of aligned individual second conveyor plates 50. The second flexible track conveyor assembly 44 also includes or has a second drive assembly 52, such as includes second track supports 54 along the frame second lateral side 22 whereabout the second endless flexible track conveyor 46 is generally disposed. The second drive assembly 52 is desirably at least in part fixed relative to the frame 12. In accordance with certain preferred embodiments of the invention, the second track supports 54 are desirably fixed relative to the frame 12. For example and as shown, the second drive assembly 52 includes a plurality of sprocket wheels 56, including a second sprocket wheel 60, such as are desirably rotatably fixed to the frame 12 and in operational communication with the second endless flexible track conveyor 46 and, more particularly, in operational communication with at least a portion of the plurality of aligned individual second conveyor plates 50. Thus, for example, the second drive assembly 52 is generally effective to drive the second endless flexible track conveyor 46.

The concrete cutting apparatus 10 also includes a third flexible track conveyor assembly 64 interposed between the first and the second track conveyor assemblies, 24 and 44, respectively. The third flexible track conveyor assembly 64, similar to the first and second flexible track conveyor assemblies 24 and 44, respectively, is generally composed of a third endless flexible track conveyor 66, such as composed of a plurality of aligned individual third conveyor plates 70.

A blade mount 82, whereat a rotatable cutting blade 94 (schematically shown in FIG. 2) is disposed or otherwise appropriately mounted, is positioned between the first and second endless flexible track conveyors 26 and 46. More particularly, in the apparatus 10, the blade mount 82 is disposed between the first and third endless flexible track conveyors 26 and 66.

Those skilled in the art and guided by the teachings herein provided will understand and appreciate that rotatable cutting blades of various design and construction, such as generally suitable for the cutting of concrete, particularly, green concrete, are available and are useable in the practice of the invention. Thus, it is to be understood that the broader practice of the invention is not necessarily limited to or by the cutting blade design or construction used in the practice thereof.

The apparatus 10 also includes a motor 86 in operational communication with the rotatable cutting blade effective to rotate the cutting blade to cut into the surface of concrete over which the apparatus is conveyed. As shown, the motor 86 may desirably be fixedly connected with the body frame 12. The motor 86 is also in operational communication with the first, second and third track conveyor assemblies 24, 44 and 64 such as by a selected conventional technique so as to be effective to rotate the first, second and third flexible track conveyors, 26, 46, and 66, respectively, whereby the apparatus 10 is conveyable over the surface of concrete.

As will be understood, in conjunction with the motor 86, the apparatus 10 will typically also include ancillary components such as a fuel tank, transmission, air filter, etc. and which ancillary components do not generally form limitations on the broader practice of the invention.

The apparatus 10 also includes a handle 90 fixedly connected to the body frame 12 and effective for the guiding the apparatus 10, such as by an individual walking therebehind, as the apparatus 10 is moved across a surface of concrete to be cut. As will be appreciated, the handle 90 may have appropriate switches and/or controls (not shown), such as known in the art, mounted or connected thereto such as to facilitate walk-behind operation of the apparatus 10.

Those skilled in the art and guided by the teachings herein provided will understand and appreciate that the present invention, through the use of flexible track conveyors as the primary means of support for the apparatus on a surface of concrete over which the apparatus is conveyed, desirably avoids or minimizes such concentrating or focusing the weight of the assembly upon a concrete surface over which the apparatus is conveyed such as to minimize or avoid undesired marking or marring of the concrete surface. For example, the apparatus 10 described above, is free of surface contacting wheels or rollers such as have commonly in the past been incorporated and employed in conveying concrete cutting assemblies over concrete surfaces and which, as described above, can serve to undesirably concentrate the weight of such an assembly onto the adjacent concrete surface.

Moreover, through the mounting of the rotatable blade in close proximity between two adjacent such conveyor assemblies and, more particularly, in close proximity between two such adjacent endless flexible track conveyors, the apparatus of the invention desirably minimizes or avoids surface marking or marring, such as in the nature of surface chipping, spalling or ravelling in the near vicinity of a cut being made into the concrete surface by the action of the cutting blade.

In an effort to provide a better understanding of such features of the invention, reference is now made to FIG. 2. FIG. 2 is a simplified bottom view schematic of the concrete cutting apparatus 10, shown in FIG. 1. FIG. 2 schematically illustrates the first, second and third endless flexible track conveyors, 26, 46 and 66, respectively, with the rotatable blade 94 shown mounted and disposed between the first endless flexible track conveyor 26 and the third endless flexible track conveyor 66.

As related above, through the use of flexible track conveyors as the primary means of support for the apparatus on a surface of concrete over which the apparatus is conveyed, the concentrating or focusing the weight of the assembly upon a concrete surface over which the apparatus is conveyed and such as may result in undesired marking or marring of the concrete surface is desirably minimized or avoided. Moreover, by way of mounting of the rotatable blade 94 in close proximity between the two adjacent endless flexible track conveyors 26 and 66, respectively, such conveyors can serve to desirably minimize or avoid surface marking or marring, such as in the nature of surface chipping, spalling or ravelling in the near vicinity of a cut being made into the concrete surface by the action of the cutting blade 94.

As will be appreciated by those skilled in the art and guided by the teachings herein provided, the dimensions of each of the two or more flexible track conveyors included in a concrete cutting apparatus in accordance with the invention can be appropriately varied and selected to best fit or match the requirements of a particular application. For example, as perhaps best seen by reference to FIG.2, while for factors such as ease of manufacture and production, it may be desirable that such first and second flexible track conveyor 26 and 46, respectively, be of similar construction and dimensions, in particular applications it may desirable to employ a centrally disposed flexible track conveyor 66 that, as shown, is narrower in width than either of such end conveyors 26 and 46.

While the invention has been described above making specific reference to an embodiment having three track conveyor assemblies and thus three flexible track conveyors, it is to be understood that the broader practice of the invention is not necessarily so limited. For example, at least for particular applications, the invention may preferably be practiced employing an apparatus in accordance with the invention and such as only includes a pair of such track conveyors.

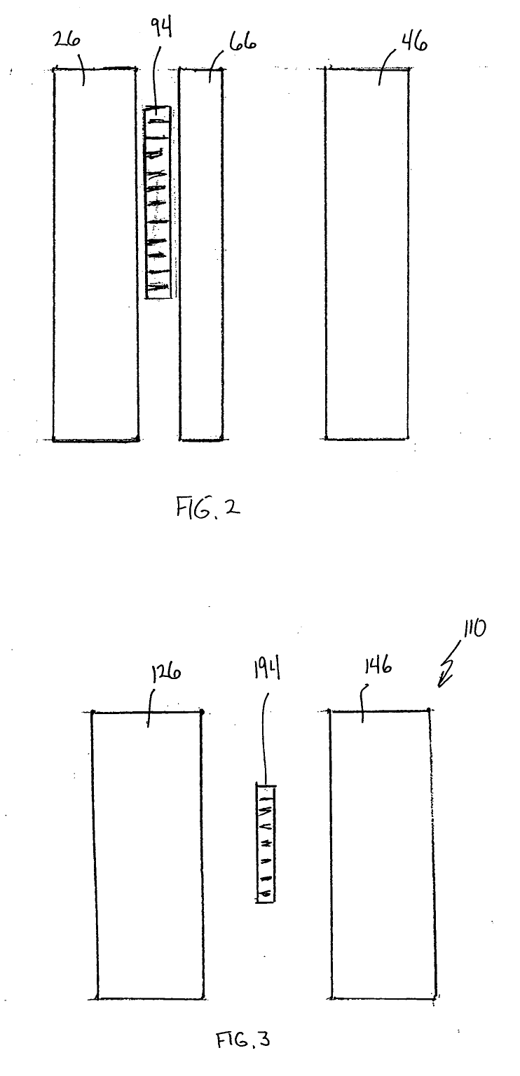

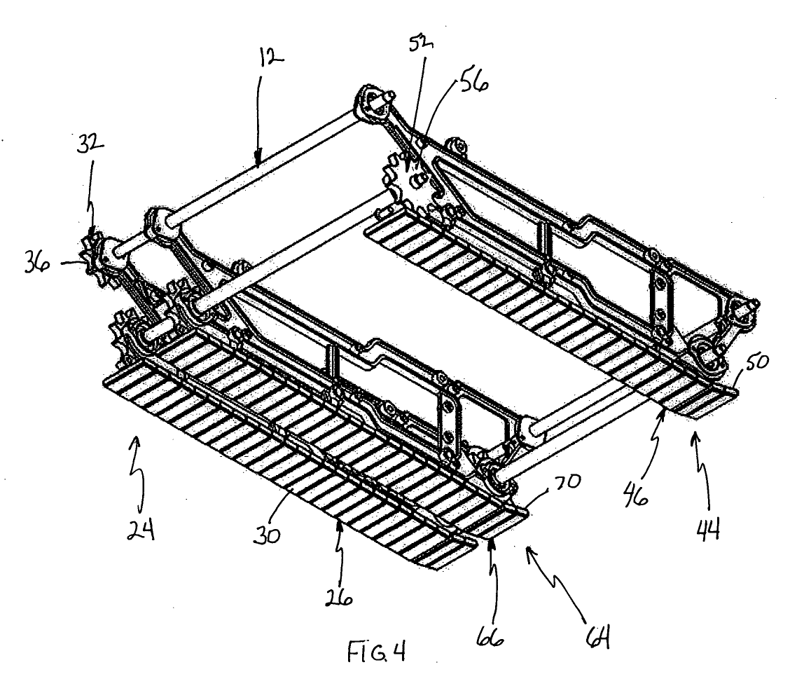

FIG. 3 is a simplified bottom view schematic, similar to that shown in FIG. 2, but now illustrating the bottom view of a concrete cutting apparatus 110, in accordance with another preferred embodiment of the invention. In particular, the concrete cutting apparatus 110 incorporates a first endless flexible track conveyor 126 and a second endless flexible track conveyor 146, with a rotatable blade 194 shown mounted and disposed directly between the first endless flexible track conveyor 126 and the second endless flexible track conveyor 146.

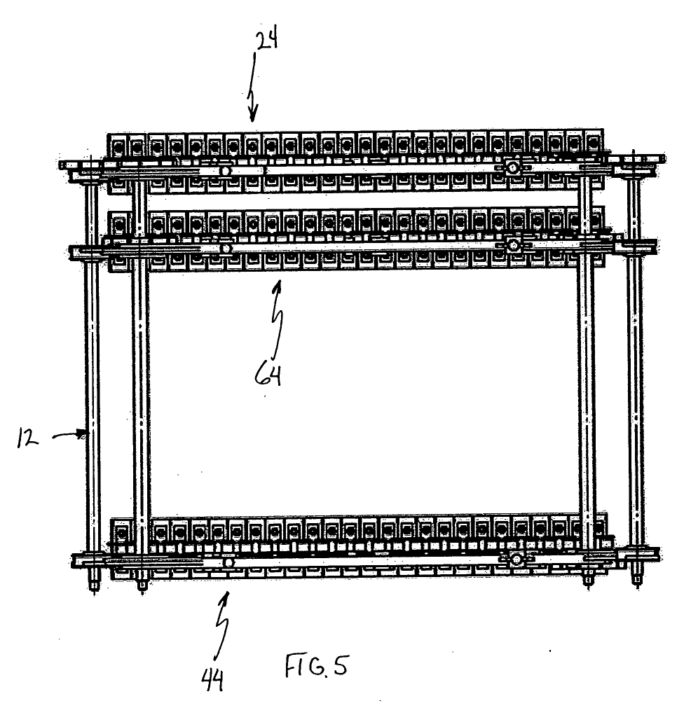

To further enhance an understanding of the subject invention development, reference is now made to FIGS. 4-6 which illustrate different views of selected portions of the apparatus 10 for cutting concrete, shown in FIG. 1. More particularly, FIGS. 4-6 illustrate portions of the above-described first, second and third flexible track conveyor assemblies, 24, 44 and 64, respectively.

As described above, the first flexible track conveyor assembly 24 includes the first endless flexible track conveyor 26 generally composed of the plurality of aligned individual first conveyor plates 30. The first flexible track conveyor assembly 24 also includes or has the first drive assembly 32 such as includes the plurality of sprocket wheels 36. The sprocket wheels 36 are desirably rotatably fixed to the frame 12 and in operational communication with the first endless flexible track conveyor 26 and, more particularly, in operational communication with at least a portion of the plurality of aligned individual first conveyor plates 30.

As similarly described above, the second flexible track conveyor assembly 44 includes the second endless flexible track conveyor 46 generally composed of the plurality of aligned individual second conveyor plates 50. The second flexible track conveyor assembly 44 also includes or has the second drive assembly 52 such as includes the plurality of sprocket wheels 56. The sprocket wheels 56 are desirably rotatably fixed to the frame 12 and in operational communication with the second endless flexible track conveyor 46 and, more particularly, in operational communication with at least a portion of the plurality of aligned individual second conveyor plates 50.

The third flexible track conveyor assembly 64 includes the third endless flexible track conveyor 66 generally composed of the plurality of aligned individual second conveyor plates 70.

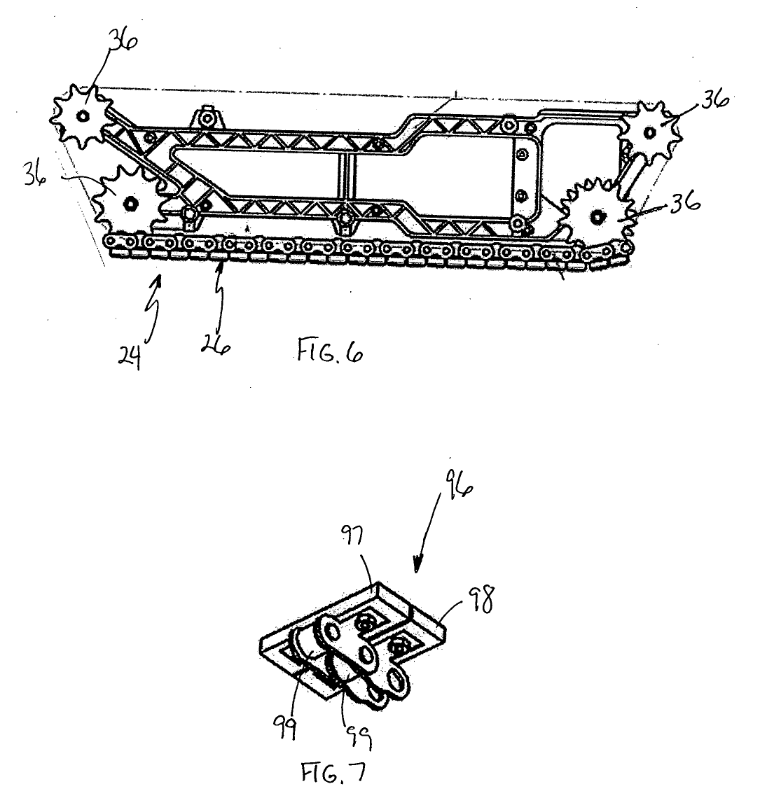

Turning to FIG. 7, for an endless flexible track conveyor in accordance with one preferred embodiment of the invention and generally designated by the reference numeral 96, there is illustrated an adjacent pair of conveyor plates, 97 and 98, respectively, of an endless flexible track conveyor in accordance with one preferred embodiment of the invention. As shown, the conveyor plates 97 and 98 may desirably include or have joined thereto, conveyor roller links 99, such as known in the art, and such as may be joined or connected together or otherwise in operational communication with an appropriate drive assembly whereby the conveyor plates move in a desired conveyor belt manner such as to appropriately convey a subject apparatus over an adjacent concrete surface.

As will be appreciated, by reducing the number of components or elements, particularly, moving components or elements such as conveyors and associated supports and drive assemblies, an apparatus of improved reliability and ease of operation may result. In view of the above, it will be appreciated that the invention provides an apparatus for cutting concrete, particularly green concrete, and which apparatus avoids undesirably concentrating or focusing the weight of the assembly such as to minimize or avoid undesired marking or marring of the concrete surface. Moreover, the invention provides an apparatus for cutting concrete, particularly green concrete, and which apparatus desirably minimizes or avoids surface marking or marring in the vicinity of a joint or seam cut into the concrete surface.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. An apparatus for cutting a surface of concrete over which the apparatus is conveyed, the apparatus comprising:
a frame having opposed and spaced apart lead and trail ends, the frame also having opposed and spaced apart first and second lateral sides;
a first flexible track conveyor assembly generally disposed along the frame first lateral side, the first flexible track conveyor assembly including a first endless flexible track conveyor disposed about first track supports along the frame first lateral side, wherein the first track supports consist essentially of supports fixed relative to the frame;
a second flexible track conveyor assembly generally disposed along the frame second lateral side, the second flexible track conveyor assembly including a second endless flexible track conveyor disposed about second track supports along the frame second lateral side, wherein the second track supports consist essentially of supports fixed relative to the frame;
a blade mount disposed between the first and second endless flexible track conveyors, the blade mount for mounting a rotatable cutting blade effective to cut concrete and permitting vertical adjustment of the rotatable cutting blade relative to the frame;
a motor in operational communication with the rotatable cutting blade effective to rotate the cutting blade to cut into the surface of concrete over which the apparatus is conveyed;
a motor in operational communication with the first and second track conveyor assemblies effective to rotate the first and second flexible track conveyors, respectively; and
a handle fixedly connected to the frame and effective for guiding the apparatus across a surface of concrete to be cut.

2. The apparatus of claim 1 wherein a single motor is in both operational communication with the rotatable cutting blade effective to rotate the cutting blade and in operational communication with the first and second track conveyor assemblies effective to respectively rotate the first and second flexible track conveyors.

3. The apparatus of claim 1 wherein the first track conveyor assembly comprises a first drive assembly effective to drive the first endless flexible track conveyor.

4. The apparatus of claim 3 wherein the second track conveyor assembly comprises a second drive assembly effective to drive the second endless flexible track conveyor.

5. The apparatus of claim 1 wherein at least the first endless flexible track conveyor comprises a plurality of aligned individual first conveyor plates.

6. The apparatus of claim 5 wherein the first track conveyor assembly comprises a first drive assembly effective to drive the first endless flexible track conveyor and wherein the first drive assembly includes at least a first sprocket wheel in operational communication with a portion of the plurality of aligned individual first conveyor plates.

7. The apparatus of claim 6 wherein the second endless flexible track conveyor comprises a plurality of aligned individual second conveyor plates, the second track conveyor assembly comprises a second drive assembly effective to drive the second endless flexible track conveyor and wherein the second drive assembly includes at least a second sprocket wheel in operational communication with a portion of the plurality of aligned individual second conveyor plates.

8. The apparatus of claim 1 wherein flexible track conveyors form the primary means of support for the apparatus on a surface of concrete over which the apparatus is conveyed.

9. The apparatus of claim 1 additionally comprising a third flexible track conveyor assembly interposed between the first and the second track conveyor assemblies, the third flexible track conveyor assembly including a third endless flexible track conveyor.

10. The apparatus of claim 9 wherein the third endless flexible track conveyor comprises a plurality of aligned individual third conveyor plates.

11. The apparatus of claim 10 wherein the third conveyor plates are of narrower width than the first and second conveyor plates.

12. The apparatus of claim 1 wherein the first, second and third flexible track conveyors form the primary means of support for the apparatus on a surface of concrete over which the apparatus is conveyed.

13. An apparatus for cutting concrete a surface of concrete over which the apparatus is conveyed, the apparatus comprising:
a frame having opposed and spaced apart lead and trail ends, the frame also having opposed and spaced apart first and second lateral sides;
a first flexible track conveyor assembly generally disposed along the frame first lateral side, the first flexible track conveyor assembly comprising a first endless flexible track conveyor having a plurality of aligned individual first conveyor plates, the first flexible track conveyor assembly also comprising a first drive assembly at least in part fixed relative to the frame, the first drive assembly having at least a first sprocket wheel in operational communication with a portion of the plurality of aligned individual first conveyor plates and effective to drive the first endless flexible track conveyor;
a second flexible track conveyor assembly generally disposed along the frame second lateral side, the second flexible track conveyor assembly comprising a second endless flexible track conveyor having a plurality of aligned individual second conveyor plates, the second flexible track conveyor assembly also comprising a second drive assembly at least in part fixed relative to the frame, the second drive assembly having at least a second sprocket wheel in operational communication with a portion of the plurality of aligned individual second conveyor plates and effective to drive the second endless flexible track conveyor;
a blade mount disposed between the first and second endless flexible track conveyors, the blade mount for mounting a rotatable cutting blade effective to cut concrete and permitting vertical adjustment of the rotatable cutting blade relative to the frame;
a motor in operational communication with the rotatable cutting blade effective to rotate the cutting blade to cut into the surface of concrete over which the apparatus is conveyed, the motor also in operational communication with the first and second track conveyor assemblies effective to rotate the first and second flexible track conveyors, respectively; and
a handle fixedly connected to the frame and effective for guiding the apparatus across a surface of concrete to be cut.

14. The apparatus of claim 13 wherein flexible track conveyors form the primary means of support for the apparatus on a surface of concrete over which the apparatus is conveyed.

15. The apparatus of claim 13 additionally comprising a third flexible track conveyor assembly interposed between the first and the second track conveyor assemblies, the third flexible track conveyor assembly including a third endless flexible track conveyor.

16. The apparatus of claim 15 wherein the third endless flexible track conveyor comprises a plurality of aligned individual third conveyor plates.

17. The apparatus of claim 15 wherein the first, second and third flexible track conveyors form the primary means of support for the apparatus on a surface of concrete over which the apparatus is conveyed.

18. An apparatus for cutting a surface of concrete over which the apparatus is conveyed, the apparatus comprising:
a frame having opposed and spaced apart lead and trail ends, the frame also having opposed and spaced apart first and second lateral sides;
a first flexible track conveyor assembly generally disposed along the frame first lateral side, the first flexible track conveyor assembly including a first endless flexible track conveyor;
a second flexible track conveyor assembly generally disposed along the frame second lateral side, the second flexible track conveyor assembly including a second endless flexible track conveyor;
a blade mount disposed between the first and second endless flexible track conveyors, the blade mount for mounting a rotatable cutting blade effective to cut concrete and permitting vertical adjustment of the rotatable cutting blade relative to the frame;
a motor in operational communication with the rotatable cutting blade effective to rotate the cutting blade and in operational communication with the first and second track conveyor assemblies effective to rotate the first and second flexible track conveyors, respectively; and
a handle fixedly connected to the frame and effective for guiding the apparatus across a surface of concrete to be cut,
wherein flexible track conveyors form the primary means of support for the apparatus on a surface of concrete over which the apparatus is conveyed.

19. The apparatus of claim 18 wherein at least one of the first and second endless flexible track conveyors comprises a plurality of aligned individual conveyor plates.

20. The apparatus of claim 19 wherein each of the first and second endless flexible track conveyors comprises a plurality of aligned individual conveyor plates.
